(19) United States
(12) Patent Application Publication
(10) Pub. No.: US 2001/0034710 A1
(43) Pub. Date: Oct. 25, 2001

(54) Electronic data circulation management method

(76) Inventors: Yoshio Hosoya, Chiba (JP); Hideyuki Hashimoto, Chiba (JP); Yoshikatsu Hosoya, Chiba (JP)

Correspondence Address: SUGHRUE, MION, ZINN,, MACPEAK & SEAS, PLLC, 2100 Pennsylvania Avenue, N.W., Washington, DC, 20037, US

(21) Appl. No.: 09/799,346

(22) Filed: Mar. 6, 2001

(30) Foreign Application Priority Data
Mar. 6, 2000 (JP) 2000-61276
Jul. 24, 2000 (JP) 2000-223019

(51) Int. Cl. G06F 17/60; G06F 17/30

(52) U.S. Cl. 705/51; 707/9; 707/10; 707/104.1

(57) ABSTRACT

To expand the collection market of electronic data to be collected, on the Internet which is communication lines, a plurality of collectors are connected to an issuer who issues electronic data as a collection target for the collectors, the issuer expresses the issue of the electronic data to the collectors, and when a contract on the transfer of the electronic data is concluded between the issuer and the collectors, the issuer issues all the contents of the electronic data on which contract has been concluded to the collectors without leaving anything on the part of the issuer.

### BACKGROUND OF THE INVENTION

1. Field of the Invention

The present invention relates to a method of managing the circulation of electronic data by circulating the electronic data as a collection target over an electronic space and forming an electronic data collection market on the electronic space.

2. Description of the Prior Art

Heretofore, gathering and collection have been the basic desire of the human being. For example, people collect grain to keep off hunger and wealthy people came into existence by collecting assets after the development of the money economy. The term “collection” is defined as the act of collecting many items based on the standard of predetermined value by at least one man. The term “gathering” represents a concept including “collection” and is defined as the act of simply gathering many items whether it is based on the standard of predetermined value or not.

Turning eyes to the world of children, they have always been collecting and gathering items which differ by generation. In those days, children collected pasteboard dumps, glass beads and baseball player's pictures whereas in these days, children gather and collect the cards of animation characters. Collection and gathering stimulate a feeling of personal satisfaction with the envy of other people.

Stamps, Japanese dolls, antiques and precious toys which have been collected are numerous and the values of items collected and gathered are generally not recognized in most cases. However, these items are very precious treasures which cannot be substituted by anything for people who collect and gather these items. A money value is given to items which have not attracted much attention due to a recent “treasure boom” and the expression “my boom” appears to express wild enthusiasm existent within the heart of a collector.

In the 1990's, Japan saw the sudden arrival of the computerized society. Along with this, a huge volume of electronic data have been prepared and collected as personal documents and business materials.

However, there has been no case where these electronic data were a collection target.

### SUMMARY OF THE INVENTION

The present invention proposes a method of managing the circulation of electronic data as a collection target and aimed to expand the collection market of electronic data.

In the present invention, an electronic space market in which at least the terminal of an electronic data issuer can be connected to the terminals of collectors and electronic data which can be a collection target in the electronic space market are issued.

A use area is assigned to each collector in the above electronic space market and electronic data which has been issued to each collector as a collection target in a predetermined number in the electronic space market is stored in the use area of each collector.

In this case, the use area is set in a management server and circulation management is carried out such that each collector can use the above electronic data stored in the use area only when he/she accesses the use area using an identification means assigned to him/her.

Further, when a contract on the transfer of the above electronic data is concluded between collectors having their use areas in the above server, the above management server carries out circulation management by moving the above electronic data from the use area assigned to one collector as a transferrer to the user area assigned to the other collector as a transferee.

In the above case, to monitor illegality in the above server, information for finding copied electronic data when the electronic data stored in the above server is copied in the server is added to the above electronic data by the issuer of the electronic data, or a back-up server is provided to see the record hysteresis of the server.

Information for securing the reliability of the electronic data is added to the above electronic data.

Information which forms the standard of the collection value of the electronic data is added to the above electronic data by the issuer of the electronic data.

Additional information on the issuer, the current proprietor and the record of past proprietors is included in the above electronic data.

The above and other objects, advantages and features of the present invention will become more apparent from the following description when taken into conjunction with the accompanying drawings.

### BRIEF DESCRIPTION OF THE ACCOMPANYING DRAWINGS

FIG. 1 is a schematic diagram for explaining a circulation management method in the issue and transfer market of electronic data to be collected in the present invention;

FIG. 2 is a schematic diagram for explaining a means of preventing the illegal copying or illegal movement of electronic data to be collected in the present invention;

FIG. 3 is a schematic diagram for explaining a circulation management method in the transfer or exchange market of electronic data to be collected in the present invention;

FIG. 4 is a schematic diagram for explaining a circulation management method in the transfer or exchange market of electronic data to be collected in the present invention; and

FIG. 5 is a diagram for explaining additional information.

### DETAILED DESCRIPTION OF THE PREFERRED EMBODIMENTS

The present invention is directed to electronic data as a collection target. The electronic data refers to data used in computers and over the Internet. The electronic data includes prepared electronic business documents and images taken by digital cameras. In the present invention, scarcity value, exchange value or market value is given to the electronic data to turn the electronic data to be a collection target in order to sharply expand the scale of the collection market.

Examples of the electronic data as a collection target include trading cards, sound sources, documents and others which are available as electronic data.

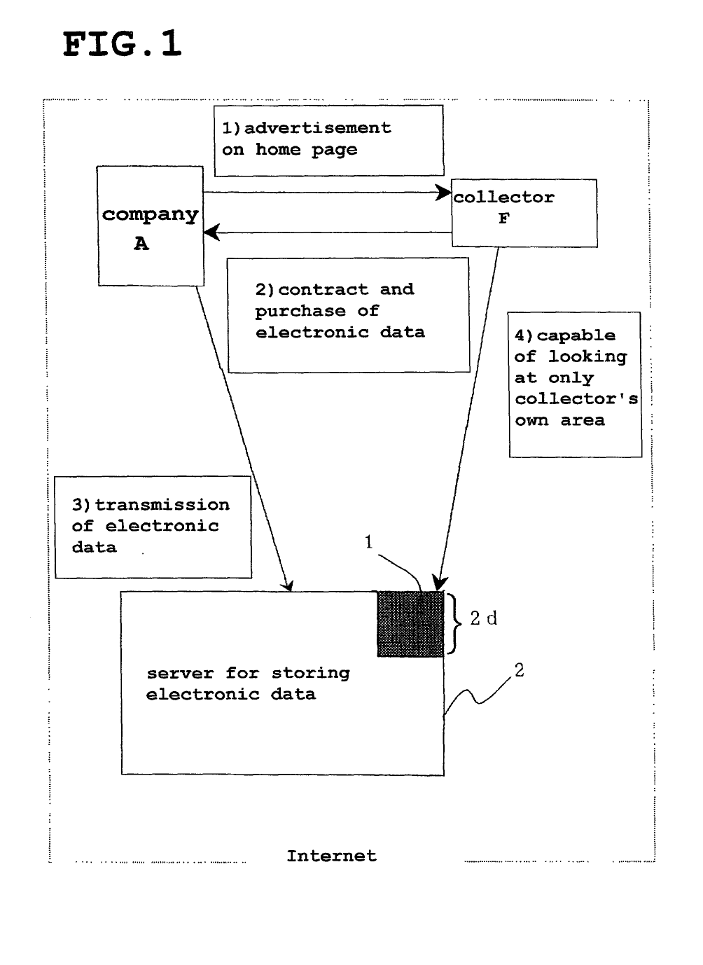

The method of managing the circulation of electronic data according to a preferred embodiment of the present invention is such as shown in FIG. 1. A plurality of collectors F are connected to an issuer A which issues electronic data 1 as a collection target by the Internet as communication lines, and the issuer A expresses the issue of the above electronic data 1 to the collectors F and issues all the contents of the electronic data 1 to a collector F without leaving the contents on the part of the issuer when the issuer A and the collector F conclude a contract on the transfer of the electronic data 1. Therefore, as the proprietorship of the issued electronic data 1 is completely transferred to the collector F from the issuer A, it can be secured that the issued original electronic data 1 is only one and the electronic data can be a collection target, thereby making it possible to form the electronic space market of the electronic data 1 through the Internet.

This will be further detailed hereinbelow.

As shown in FIG. 1, when the issuer A is to issue trading cards as electronic data 1, the issuer A prepares a large number of trading cards as electronic data 1. The number of electronic data 1 to be issued is predetermined. For example, the number may be only 10 or 10 million. The number cannot be changed even by the issuer A freely after transfer. (Even when a trading card of the same quality is to be issued, it must be proved that there is a difference between the two by identification information such as issue date or the like.)

The issuer A opens a home page on the Internet and seeks a membership. The collector F which responds to this and concludes a contract with the issuer A can receive a predetermined number of electronic data 1 in accordance with the amount of money paid to the issuer A. The collector F cannot specify the type of electronic data 1 and the type of the electronic data 1 is desirably random.

The proprietorship of the electronic data 1 purchased by the collector F is transferred from the issuer A to the collector F. The proprietorship means that the collector F can sell the electronic data 1 at his own free will without contacting the issuer A. The electronic data 1 whose proprietorship has been transferred to the collector F is stored in an electronic recording medium which is a use area assigned to each collector F.

The electronic recording medium may be a floppy disk (FD), hard disk (HD), optical magnetic disk (MO), Zip drive or CD-ROM managed by each collector, or a divided use area 2a assigned to each collector F of a server 2 having a large storage area. Reference symbols such as 1, 2, 2a, A and F are omitted except when necessary.

As shown in FIG. 1, a system for assigning the divided use areas of the server having a large storage area to collectors (to be referred to as “divided area use technology” hereinafter) is a technology which is generally used in such a business field as server rental.

When the divided area use technology for the above server is used, an electronic identification number as an identification means is given to each collector so that he/she can access a divided use area assigned to him/her to see only the contents of electronic data stored in the area and cannot see the contents of electronic data stored in a divided use area assigned to another collector.

In this case, 100% of the electronic data may be stored in the divided use area of the server, or only key data for using the electronic data may be stored in the divided use area of the server and the remaining data may be stored on the part of the collector. The management of the server may be carried out by a person other than the collector, for example, the issuer A or a management company B which will be described hereinafter.

When electronic data is stored in an electronic recording medium managed by each collector, there is a chance that a third party (including another collector, the same shall apply hereinafter) may access the electronic recording medium managed by the collector illegally to see the contents of the electronic data. That is, the secrecy of the electronic data cannot be secured and the collection value of the electronic data cannot be maintained, whereby the electronic data may not be a collection target any more.

In contrast to this, when the divided area use technology for the server and the above-mentioned identification means such as the electronic identification technology are employed, the third party cannot see the contents of electronic data owned by each collector if he/she cannot obtain the electronic identification number, whereby the collection value of the electronic data can be maintained and the electronic data can be a collection target. Even in this case, it cannot be completely prevented that the third party obtains the electronic identification number illegally to peep the electronic data of another collector. However, as the effect of preventing the third party from peeping the electronic data as much as possible can be expected, the secrecy of electronic data can be more secured when the divided area use technology for the server and the electronic identification technology are used than when the electronic data is stored in an electronic recording medium managed by the collector, whereby the collection value of the electronic data can be maintained and the electronic data can be a collection target.

If the electronic data stored in the electronic recording medium can be copied freely, the originality of the electronic data cannot be secured and the reliability of the electronic data is lost, thereby reducing the value of the electronic data as a collection target.

To disable the copying of the electronic data is difficult in the current state of art.

For example, assume that the electronic data is stored in a medium having no intelligence (having no computing function) such as a floppy disk or CD.

One of methods of limiting the use of the electronic data is encoding. Since encoded electronic data cannot be decoded without key data for decoding it and it is substantially impossible to use a set of undecoded electronic data (for example, hexadecimal information such as 1154fd3bla), it can be said that this limits the use of electronic data.

However, when the copying of electronic data is to be limited, it differs from the limitation of the use of electronic data. For example, this means that the name of a file or encoded electronic data can be changed by using software which can read a set of encoded electronic data which is not decoded yet (apart from whether this change is meaningful or not). Therefore, encoding cannot be a decisive method for preventing the copying of electronic data.

Meanwhile, when it is assumed that electronic data is stored in a storage medium having an intelligent function, software for decoding encoded electronic data can be used by this intelligent function. The intelligent medium is a personal computer or portable telephone having a computing function and storage function of a certain level. If software for these equipment has the function of finding electronic data which has been illegally copied by means of the above binary text editor, it will suffice. Even when illegal copying cannot be prevented completely, illegal use can be prevented completely.

Then, in this embodiment, as shown in FIG. 1, the divided area of the server is used by the electronic identification technology.

That is, when the above divided area use technology for the server and the electronic identification technology are used, electronic data cannot be illegally copied unless the third party obtain an electronic identification number illegally. Therefore, the reliability of electronic data can be secured and the electronic data can be a collection target.

To prevent the third party from obtaining an electronic identification number to take out electronic data to the outside of the server and illegally copy it, copy prevention information which will be described hereinafter must be added to the electronic data. However, to prevent the third party from obtaining an electronic identification number illegally to copy electronic data in the server illegally, the copy prevention information which will be described hereinafter does not always need to be added to the electronic data.

That is, the following methods are conceivable to monitor illegal copying.

Information on how many pieces of the data have been issued or information on what is the serial number of the data (identification information such as the serial number) is added to the electronic data. That is, when the electronic data stored in the server is copied in the server, whether the electronic data is illegally copied or not in the server can be monitored by adding information for finding the copied electronic data. That is, if the number of electronic data is larger than the issued number or if the serial number is overlapped, illegal copying can be found and the data of a collector who has no transaction record such as a transfer contract may be forcedly erased.

A back-up server for viewing the record hysteresis of the server is provided to monitor whether the electronic data is illegally copied in the server.

Since there is a chance that not only the above storage server but also the back-up server are accessed by an act so called “hacking” to change the record hysteresis of the back-up server, the back-up server is desirably multiplexed.

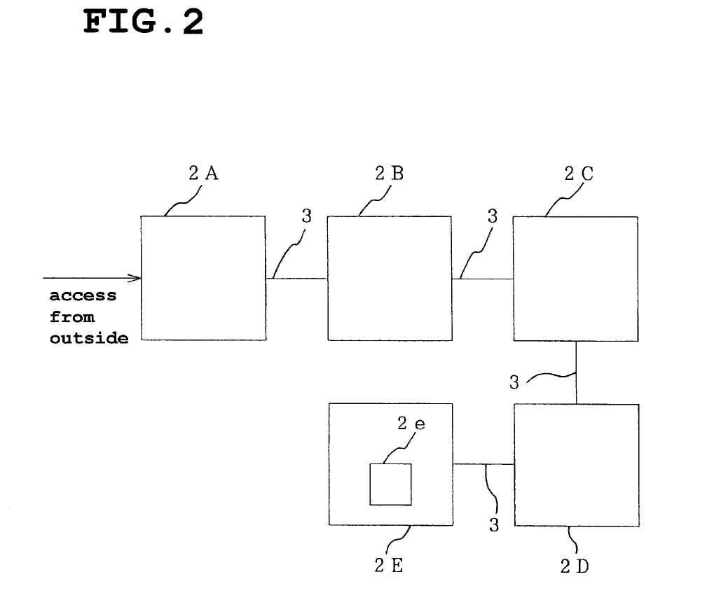

For example, as shown in FIG. 2, a plurality of back-up servers 2B to 2E are connected in series to the end of the storage server 2A which can be accessed from the outside to copy electronic data to the back-up servers of the latter stage regularly. In this case, the storage server 2A and the back-up servers 2B to 2E are connected by a telephone line or communication line 3 such as LAN cable. The communication line 3 is physically disconnected while back-up is carried out.

Out of the back-up servers 2B to 2E connected in series, the last back-up server 2E is provided with conformity judging means 2e for comparing the record hysteresis of the above servers.

In the above constitution, only the storage server 2A can be accessed from the outside and electronic data stored in the storage server 2A is copied to the back-up server 2B through the communication line 3 regularly and further copied to the back-up servers 2C, 2D and 2E of the latter stage. In this case, the back-up server 2B may be illegally accessed from the outside through the storage server 2A and the electronic data in the back-up server 2B may be illegally copied by the act of a person called “hacker”.

However, while the storage server 2A is connected to the back-up server 2B at the time of back-up, connection between the back-up servers 2B and 2C is disconnected and the hacker cannot access the backup server 2C.

While the back-up servers 2B and 2C are connected to each other, connection between the storage server 2A and the back-up server 2B and connection between the back-up servers 2C and 2D are physically disconnected.

Similarly, connection at the time of backing up the electronic data and physical disconnection are repeated between the back-up servers 2C and 2D and between the back-up servers 2D and 2E sequentially.

Thus, the back-up of electronic data and the connection and physical disconnection of the communication line 3 are carried out continuously so that the copy of the electronic data reaches the last back-up server 2E.

Thereafter, it is confirmed by the conformity judging means 2e in the above back-up server 2E whether the illegal copy of the backed up electronic data is existent or not.

That is, the circulation predetermined for the same type of electronic data and the number of the backed up electronic data are compared with each other. When the number of electronic data is larger than the above circulation, the electronic data is hacked and the confirmation of the proprietor is carried out based on the transaction record. As for the confirmation of the proprietor, the conformity judging means 2e may be provided with this function or only the confirmation of the proprietor may be carried out by another server or the like.

Thus, a server relatively close to the outside, such as the storage server 2A and the back-up server 2B, may be illegally accessed from the outside but if they have a function to prevent illegal use caused by the illegal access, the server is satisfactory in terms of the storage of electronic data. Therefore, the conformity judging means 2e is provided to the back-up server 2E which cannot be accessed from the outside when it is physically disconnected as described above in order to judge the illegal copying of the electronic data on the surface layer server such as the storage server 2A and erase the copied electronic data, whereby the reliability of the electronic data can be secured and the electronic data can be a collection target.

If copy prevention information can be added to the electronic data itself as will be described hereinafter, even when an electronic recording medium managed by each collector is used to store the electronic data or when the server is used, the electronic data cannot be illegally copied. However, when an individual (for example, a collector) is an issuer, it may be difficult for him/her to add copy prevention information to electronic data. In this case, the above-described method of monitoring illegal copying and the above server are used to secure the reliability of electronic data more than when an electronic recording medium managed by each collector is used to store the electronic data and the electronic data can be a collection target.

As described above, if copy prevention information is added to the electronic data itself as information for securing the reliability of the electronic data by the issuer of the electronic data by a checksum system, even when the electronic recording medium managed by each collector is used to store the electronic data, or when the server is used, the electronic data cannot be copied.

Therefore, since the reliability of the electronic data can be secured, the scarcity value, exchange value or market value of the electronic data can be maintained, and the electronic data can be a collection target in this case, the collection market of electronic data as a collection target can be formed through the Internet and the scale of the market can be expanded.

Even when copy prevention information is added to the above electronic data itself, information on how many pieces of the data are issued and what is the serial number of the data is added to the electronic data itself as information which forms the basis of the collection value of the electronic data by the issuer. Thereby, each collector can know the scarcity value, exchange value and market value of the electronic data issued and the electronic data can be a collection target, thereby making it possible to form the collection market of the electronic data as a collection target through the Internet and expand the scale of the market.

As described above, all the procedures from the issue of electronic data as a collection target to circulation and actual collection are carried out on an electronic space such as the Internet having high secrecy, thereby making it possible to exclude all the barrier conditions to a collection act such as locality, time and the viewpoints of other people and expand the scale of the collection market.

While the method of managing circulation from the issue of electronic data to the transfer of proprietorship has been mainly described above, a circulation management method for the transfer (including purchase and sale, the same shall apply hereinafter) or exchange of electronic data between collectors will be described hereinbelow.

If the random distribution of electronic data is carried out completely by the issuer A, imperfect data as a collection target (electronic data which cannot be acquired) or the overlapping of electronic data must occur at the collector F. If the collector F aims perfect collection, the transfer or exchange of electronic data between collectors is necessary. The reason why the transfer and exchange markets of electronic data as a collection target are necessary is derived from the mentality of collectors.

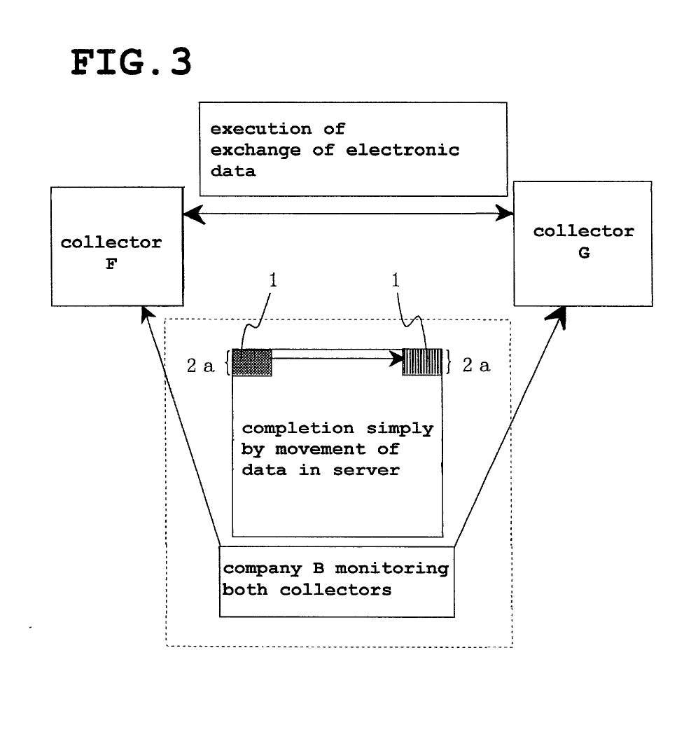

In this case, as shown in FIG. 3, a plurality of collectors F and G who are going to transfer or exchange electronic data as a collection target are connected to each other by the Internet as a communication line, the collector F expresses his desire to transfer or exchange the above electronic data to the other collector G in an electronic space, and when an contract on the transfer or exchange of the above electronic is concluded between the collectors F and G, the proprietorship of the electronic data is transferred to the other collector. That is, it is assumed that there is the collector G who has the same collection hobby as the collector F. The transfer or exchange of electronic data means that the electronic data owned by the collector F is transferred to the collector G or the electronic data owned by the collector G is transferred to the collector F like transfer or exchange in the real world when the collector F and the collector G carry out the transfer or exchange of the electronic data.

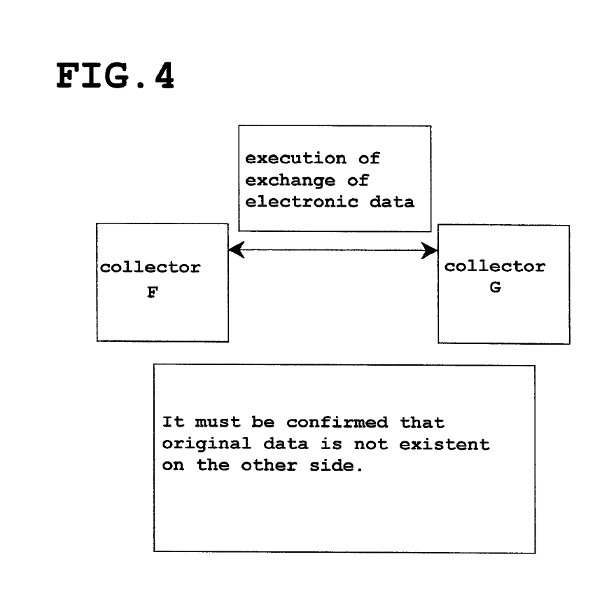

In this case, theoretically, as shown in FIG. 4, the transfer or exchange of the electronic data may be directly carried out between the collectors F and G.

In this case, when copy prevention information is added to the electronic data by the issuer A, the electronic data cannot be specified (clicked) and the transfer or exchange of the electronic data may not be directly carried out between the collectors.

When copy prevention information is not added to the electronic data, the original electronic data can be left on the part of the transmitter. Unless it is confirmed that the electronic data, whether it is original or copy, is not left on the part of the transmitter, it has no value of collection. Even when a movable medium such as FD, removable HD or MO is mailed, the same situation as described above might occur because it is not guaranteed that the transmitter does not copy the electronic data.

Therefore, to carry out the direct transfer or exchange of electronic data between collectors, a computer incorporating software with the function of transferring electronic data completely without leaving anything on the part of the transmitter must be used.

The implementation of the above computer is not realistic from the viewpoint of costs.

To cope with this, it is desired that 100% of electronic data as a collection target should not be stored by the collector but in a server managed by a management company which is an issuer or a third party, or that key data for using the above electronic data should be stored in the server to manage the transfer or exchange of the above electronic data between the collectors.

In this embodiment, as shown in FIG. 3, the transfer or exchange of electronic data between collectors is managed using the server of the management company B as a third party or the issuer A. The above server may be identical to that shown in FIG. 1, the issuer A of FIG. 1 may be actually connected by the Internet, or the transfer or exchange circulation market of electronic data may be constructed among pure collectors by connecting only the collectors by the Internet.

That is, as shown in FIG. 3, a divided use area is assigned to each collector, a server which is managed to enable each collector to see only the contents of electronic data stored in the divided use area assigned to him/her by the collector identification technology and not the contents of electronic data stored in a divided use area assigned to another collector is used, and when a contract on the transfer or exchange of electronic data is concluded between the collectors, the contents of the electronic data on which the contract has been concluded are moved to the divided use area assigned to the new proprietor collector in the server.

In this case, the fact that a contract on the transfer or exchange of the electronic data has been concluded between the collectors F and G is informed of the company B and the transfer of the electronic data is carried out on the server managed by the company B. Stated more specifically, the company B receives a transaction record such as information on the conclusion of a contract on exchange or sale between the collectors F and G and the operator of the company B moves the electronic data manually, or software for managing the server receives the transaction record such as information on the conclusion of a contract and moves the electronic data.

As for the movement of the electronic data, a hacking problem arises like the above illegal copying.

To cope with this, as in the case of the prevention of illegal copying, as shown in FIG. 2, a plurality of back-up servers 2B to 2E are connected in series to the end of the storage server 2A which can be accessed from the outside, electronic data is copied to the back-up servers of the latter stage regularly, and the communication line 3 for connecting the servers may be physically disconnected except that back-up is carried out. Out of the back-up servers 2B to 2E connected in series, the last back-up server 2E is provided with conformity judging means 2e for comparing the record hysteresis of the above servers.

In this constitution, as in the case of the prevention of illegal copying, the back-up of electronic data and the connection and physical disconnection of the communication line 3 are carried out sequentially to send the copy of the electronic data to the last back-up server 2E and it is confirmed by the conformity judging means 2e in the back-up server 2E whether the illegal transfer of the backed up electronic data has been carried out or not.

That is, when it is found from comparison between the previous backed up data and the current backed up data that specific electronic data has been moved, conformity is confirmed by the above transaction record.

When there is no conformity between the proprietorship of the current back-up data and the transaction record, for example, when moved electronic data is existent in spite of no transaction record, it is considered that the data has been hacked and forcedly moved to the divided use area of the right proprietor.

As described above, the transfer or exchange circulation market of highly reliable electronic data is constructed among collectors and the transfer or exchange of electronic data can be realized in an electronic space such as the Internet having high secrecy among collectors. Therefore, barrier conditions to a collection act such as locality, time and the viewpoints of other people are excluded and the scale of the collection market can be expanded.

In the transfer or exchange circulation market of electronic data among collectors, if electronic data issued by the issuer A is a collection target as described above, it is secured that the original electronic data is only one. Since the divided area use technology for the server and the electronic identification technology are used, the secrecy of electronic data can be secured. The above information is added to the electronic data and the illegal use of the electronic data is judged by the back-up server, thereby making it possible to secure the prevention of illegal copying, the prevention of illegal copying and illegal movement in the server and guarantee the scarcity value, exchange value and market value of the electronic data, that is, acquisition ease of the collection value.

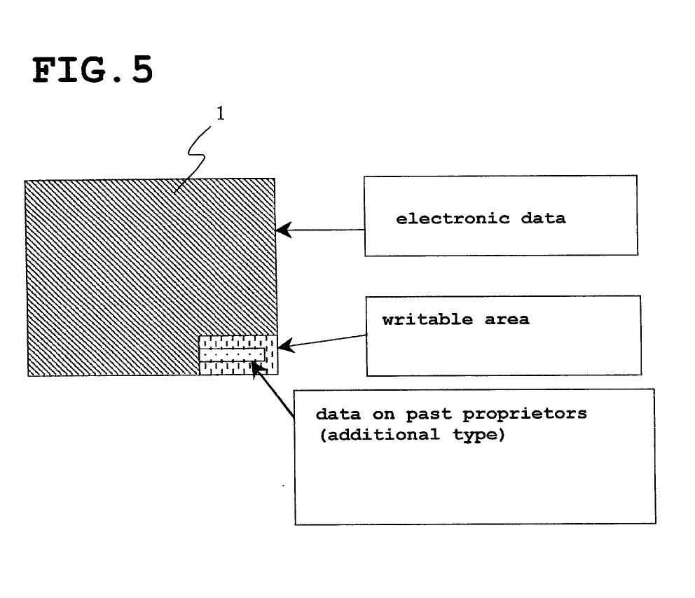

Although the electronic data to be handled in the present invention is the property of an individual which is not allowed to be changed by the issuer or the manager of the electronic data if it leaves the issuer, as shown in FIG. 5, it is desired that the current proprietor can add information that the electronic data is his/her property, such as his/her own electronic signature, to the electronic data to such an extent that it does not impair the essence of the collection target, and if there is the transfer of proprietorship, a new proprietor is able to add information that the electronic data is his/her property. The current proprietor can know the process of transfer, that is, record of proprietorship (like endorsement) from the issuer to him/her. When the transfer process of proprietorship is made known, it is proved that the electronic data is not illegally changed. If the electronic data was owned by a world's famous person or famous collector, this can increase the value of the electronic data. The reliability of the electronic data can be secured by adding a notarial individual number as additional information.

According to the above embodiment of the present invention, the number of people which collect electronic data can be tremendously increased.

People who collect some items are generally called “otaku” (this means people who like to stay home and avoid association with other people) and are given an image that they are different from ordinary people and this idea keeps many people from the act of collection. Taking trading cards related to animation as an example, how many adults are there who can stand in a line with elementary school kids in front of toy shops and buy these trading cards? Ordinary people who cannot take such kind of act give up collection itself.

According to the embodiment of the present invention, since it is possible to collect electronic data in an electronic space having high secrecy such as the Internet, collectors are released from local restrictions such as lack of a shop from which they can obtain their desired items, time restrictions such as shop opening time or psychological restrictions as described above and a great increase in the number of people who participate in collection can be expected.

According to a first aspect of the present invention, an electronic space market in which at least the terminals of an electronic data issuer and the terminals of collectors can be connected is formed and electronic data which can be a collection target is issued in the electronic space market. Therefore, the act of collecting the electronic data can be performed in the electronic space with high secrecy.

According to a second aspect of the present invention, since the above electronic data is stored in a use area for each collector set in the above electronic space market, thereby securing the secrecy of the act of collection reliably

According to a third aspect of the present invention, the above use area is set in a management server and an identification means assigned to each collector is used to access the use area. Therefore, the secrecy of electronic data can be secured more reliably.

According to a fourth aspect of the present invention, when a contract on the transfer of the above electronic data is concluded between collectors, the electronic data is moved from the use area of one collector as a transferer to the use area of the other collector as a transferee in the management server. Therefore, the originality and scarcity value of the electronic data are secured, thereby greatly contributing to the expansion of the collection market of electronic data to be collected.

According to fifth and sixth aspects of the present invention, illegal copying in the server can be found and the originality and scarcity value of the electronic data are secured in the third and fourth aspects of the invention, thereby contributing to the expansion of the collection market of the electronic data to be collected.

According to a seventh aspect of the present invention, since the reliability of the electronic data can be secured, the scarcity value, exchange value and market value of the electronic data can be maintained, thereby further contributing to the expansion of the collection market of the electronic data to be collected.

According to an eighth aspect of the present invention, the collection value of the electronic data can be known easily, thereby further contributing to the expansion of the collection market of electronic data to be collected.

According to a ninth aspect of the present invention, the value of electronic data can be enhanced, thereby further contributing to the expansion of the collection market of the electronic data to be collected.

What is claimed is:

1. A method of managing the circulation of electronic data comprising forming an electronic space market in which at least the terminal of an electronic data issuer and the terminals of collectors can be connected to each other and issuing electronic data which can be a collection target in the electronic space market.

2. The method of managing the circulation of electronic data according to claim 1, wherein a use area is assigned to each collector in the electronic space market and the electronic data which is issued in a predetermined number as a collection target to each collector in the electronic space market is stored in the use area assigned to each collector.

3. The method of managing the circulation of electronic data according to claim 2, wherein the use area is set in a management server and each collector can use the electronic data stored in the use area only when he/she accesses the use area using an identification means assigned to him/her.

4. The method of managing the circulation of electronic data according to claim 3, wherein when a contract on the transfer of the electronic data is concluded between collectors having use areas in the above server, the electronic data is moved from a use area assigned to one collector as a transferor to a use area assigned to the other collector as a transferee.

5. The method of managing the circulation of electronic data according to claim 3 or 4, wherein information for finding the copied electronic data when the electronic data stored in the server is copied in the server is added to the electronic data by the issuer of the electronic data to monitor illegality in the server.

6. The method of managing the circulation of electronic data according to any one of claims 3 to 5, wherein a back-up server for viewing the record hysteresis of the server is provided to monitor illegality in the server.

7. The method of managing the circulation of electronic data according to any one of claims 1 to 4, wherein information for securing the reliability of electronic data is added to the electronic data by the issuer of the electronic data.

8. The method of managing the circulation of electronic data according to any one of claims 1 to 7, wherein information which forms the standard of the collection value of the electronic data is added to the electronic data by the issuer of the electronic data.

9. The method of managing the circulation of electronic data according to any one of claims 1 to 8, wherein additional information such as the issuer, the current proprietor and the record of the past proprietors is included in the electronic data.
